(19) United States
(12) Patent Application Publication
(10) Pub. No.: US 2009/0045551 A1
(43) Pub. Date: Feb. 19, 2009

(54) METHOD FOR APPLYING ULTRASONIC OSCILLATION, AND RESIN COMPOSITION

(75) Inventors: Yoshiyuki Suetsugu, Chiba (JP); Atsushi Sato, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku. Tokyo (JP)

(21) Appl. No.: 12/095,749

(22) PCT Filed: Nov. 21, 2006
(86) PCT No.: PCT/JP2006/323165

§ 371 Date: Jun. 2, 2008

(30) Foreign Application Priority Data
Dec. 6, 2005 (JP) 2005-351805

(51) Int. Cl. B06B 1/10

(52) U.S. Cl. 264/443

(57) ABSTRACT

A method for applying ultrasonic vibration to a resin material in a molten state by an ultrasonic vibration application apparatus (30) being attached to a molding apparatus (10), in which a load applied to an ultrasonic oscillator is reduced and an amount of air bubbles contained in a molded article is reduced by controlling the pressure P and the melt viscosity η of the resin material at the time of applying ultrasonic vibration.

### TECHNICAL FIELD

The invention relates to a method for applying ultrasonic vibration and a resin composition. More particularly, the invention relates to a method for applying ultrasonic vibration in which the pressure and melt viscosity of a resin material or a resin composition in the molten state are controlled at the time of applying ultrasonic vibration, as well as a resin composition obtained by this ultrasonic application method.

### BACKGROUND

To improve the dispersibility of a filler in a resin composition, kneaders having screws or barrels differing in shape from conventional ones or methods for surface treatment of a filler have been developed. In view of the recent development of nano-level particles, the above-mentioned development only is insufficient to attain a high degree of dispersion of such nano-level particles.

In the case of a composition of a low viscous liquid and a filler, for example, ultrasonic vibration is generally applied by placing a container holding the liquid and the filler in an ultrasonic cleaning device or by inserting an ultrasonic-vibrating probe in this container. This method is, however, not effective for highly viscous melted polymer which tends to be damped significantly.

As for the development of kneaders, if a kneader is designed such that a high degree of stress which is necessary for the dispersion of a filler is applied to an object to be kneaded, the likelihood that the object passes the high-stress portion of a molding apparatus tends to be low. For this reason, a high degree of dispersion of a filler cannot be attained readily.

An attempt to solve these problems by using ultrasonic vibration has been proposed, for example, in Patent Document 1. This document discloses that physical properties of polymer blends or alloys are improved by using an extruder to which an ultrasonic vibration application device is attached.

This document states that physical properties of polymer blends are improved by using such a kneader, but does not refer to the dispersion of a filler. In addition, effective conditions are not disclosed.

The inventors have disclosed an ultrasonic vibration application device for applying ultrasonic vibration to a resin material and a method for melt-kneading a resin material using the ultrasonic vibration application device (see Patent Document 2).

However, depending on the operation conditions of a molding apparatus, a large load current is applied to the ultrasonic vibration application device (specifically, an oscillator) to make the operation thereof unstable, and as a result, a molded article ejected from a die may contain air bubbles. As a result, strands are likely to be cut during the step of granulation, making them difficult to be pelletized.

Although the dispersibility of a filler in a filler-containing material is improved with the aid of ultrasonic vibration, the conditions for improving dispersibility are unclear.

Patent Document 1: U.S. Pat. No. 6,528,554

Patent Document 2: WO 2005/7373

The invention has been made in view of the above-mentioned problems, and an object thereof is to provide a method for applying ultrasonic vibration in which ultrasonic vibration can be applied stably to an object with a reduced load and the physical properties of a resulting molded article and the dispersibility of a filler can be improved.

### SUMMARY OF THE INVENTION

The invention provides the following method for applying ultrasonic vibration and the resin composition.

1. A method for applying ultrasonic vibration to a resin material in a molten state by ultrasonic vibration application apparatus being attached to a molding apparatus, wherein a load applied to an ultrasonic oscillator is reduced and the amount of air bubbles contained in a molded article is reduced by controlling the pressure P and the melt viscosity η of the resin material at the time of applying ultrasonic vibration.
2. The method for applying ultrasonic vibration according to 1, wherein the pressure P and the melt viscosity η of the resin material are controlled such that the relationship of the following formula (1) or (2) is satisfied:

P≧−(⅔)log η+6 (1)

P≧−(⅔)log η+4 (2)

wherein P is the pressure (MPa) of the resin material and η is the melt viscosity (Pa·s) of the resin material at a shear rate of 10 s⁻¹; formula (1) applies to a case where the resin material is not subjected to vacuum deaerating in the molding apparatus; and formula (2) applies to a case where the resin material is subjected to vacuum deaerating in the molding apparatus.
3. A method for applying ultrasonic vibration to a resin composition containing a filler in a molten state by an ultrasonic vibration application apparatus being attached to a molding apparatus, wherein filler agglomerates are broken and dispersed by controlling the pressure P of the resin composition and the melt viscosity η of a resin material constituting the composition at the time of applying ultrasonic vibration.
4. The method for applying ultrasonic vibration according to 3, wherein the pressure P and the melt viscosity η of the resin composition are controlled such that the relationship of the following formula (3) is satisfied:

P≦−7 log η+33 (3)

wherein P is the pressure (MPa) of the resin composition and η is the melt viscosity (Pa·s) at a shear rate of 10 s⁻¹ of the resin material constituting the resin composition.
5. A resin composition obtained by ultrasonic application according to the method for applying ultrasonic vibration according to 3 or 4.

According to the invention, ultrasonic vibration can be applied to an object stably with a reduced load. Further, a filler can be dispersed effectively in a highly viscous liquid such as a melted resin. In addition, a polymer blend or an alloy with improved physical properties can be produced stably without using or by using a reduced amount of a compatibilizer. As a result, an expensive compatibilizer becomes unnecessary or the amount thereof can be reduced.

### BRIEF DESCRIPTION OF THE DRAWINGS

FIG. 1 is a schematic cross-sectional view showing the entire configuration of an extruder;

FIG. 2 is a schematic perspective view showing an ultrasonic vibration application apparatus placed in a die;

FIG. 3 is a schematic perspective view showing a channel of the die used in the embodiments;

FIG. 4 is a graph showing the relationship between the pressure P and the melt viscosity η of a resin and the application of ultrasonic vibration under the conditions shown in Table 1;

FIG. 5 is a graph showing the relationship between the pressure P and the melt viscosity η of a resin and the application of ultrasonic vibration under the conditions shown in Table 2;

FIG. 6 are enlarged photographs showing the state where filler agglomerates are broken and dispersed, in which a) shows that state where filler agglomerates are extruded without being broken and dispersed; and b) shows the state in which filler agglomerates are extruded after being broken and dispersed;

FIG. 7a is a scanning electron microscopic image of a strand, showing the state where filler agglomerates are extruded without being broken and dispersed (FIG. 6(a));

FIG. 7b is a scanning electron microscopic image of a strand, showing the state in which filler agglomerates are extruded after being broken and dispersed (FIG. 6(b));

FIG. 8 is a graph showing the relationship between the pressure P and the melt viscosity η of a resin, and the state where filler agglomerates are broken and dispersed under the conditions shown in Table 3;

FIG. 9 is a graph showing the relationship between the pressure P and the melt viscosity η of a resin, and the state where filler agglomerates are broken and dispersed under the conditions shown in Table 4; and

FIG. 10 is a graph showing the relationship between the pressure P and the melt viscosity η of a resin, and the effects brought on by the application of ultrasonic vibration.

### BEST MODE FOR CARRYING OUT THE INVENTION

The method for applying ultrasonic vibration of the invention will be described in detail.

The method for applying ultrasonic vibration of the invention is characterized in that, in a method for applying ultrasonic vibration to a resin material in a molten state by an ultrasonic vibration application device being attached to a molding apparatus, a load applied to an ultrasonic oscillator is reduced and the amount of air bubbles contained in a molded article is reduced by controlling the pressure P (hydrostatic, so-called resin pressure) and the melt viscosity η of the resin material at the time of applying ultrasonic vibration.

The molding apparatus and the ultrasonic vibration application device to be attached thereto are disclosed in detail in Patent Document 2 (WO2005/7373). Brief description will be given below, but the molding apparatus and the ultrasonic vibration application device are not limited to those mentioned below. If need arises, reference can be made to Patent Document 2.

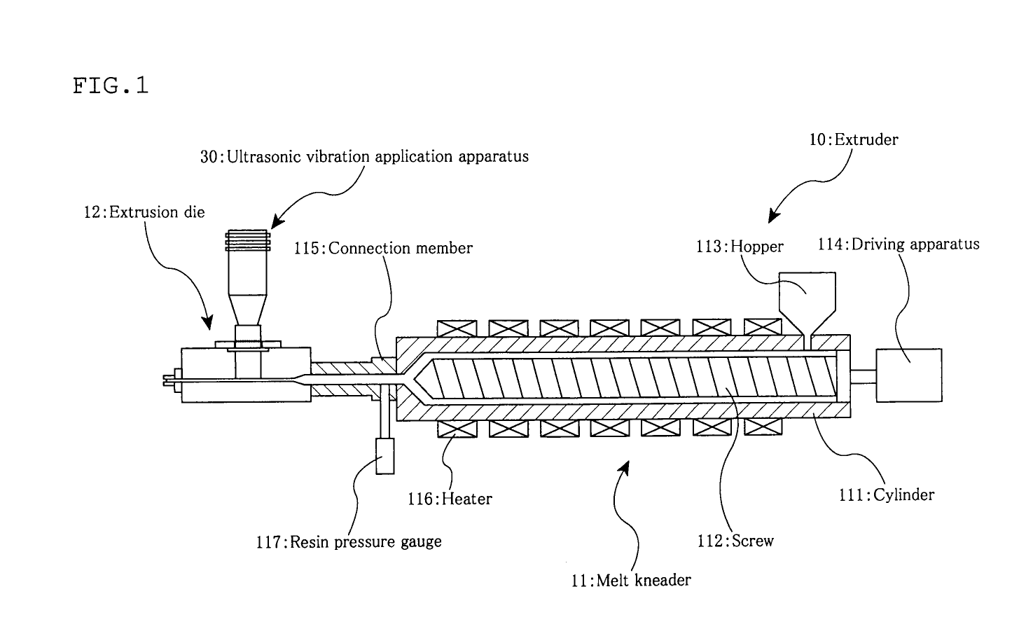

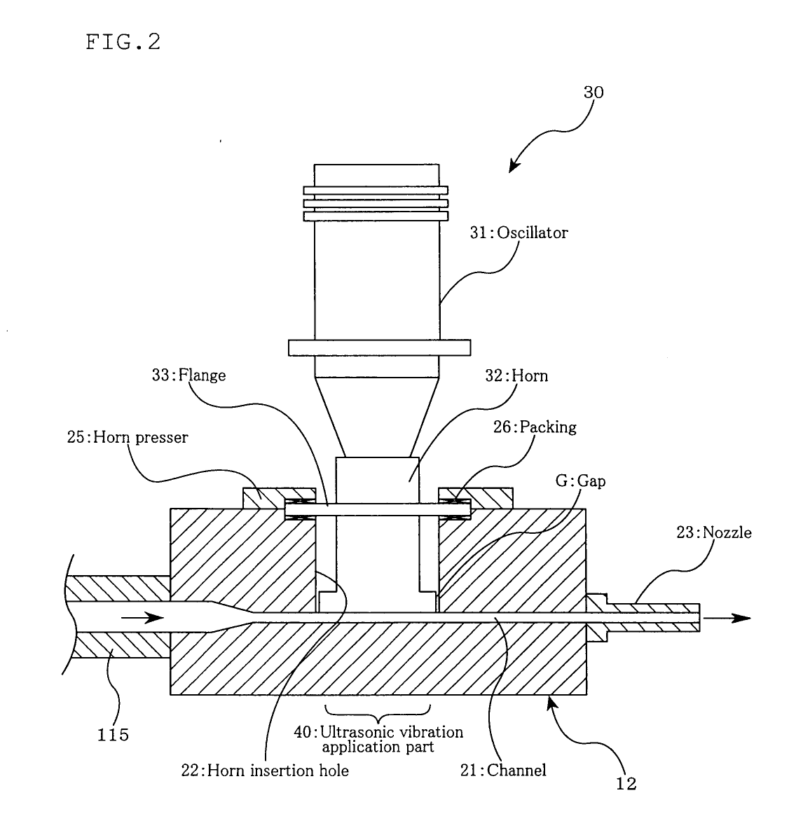

FIG. 1 is a schematic cross-sectional view showing the entire configuration of an extruder. FIG. 2 is a schematic cross-sectional view showing a state in which an ultrasonic vibration application apparatus is attached to a die.

An extruder 10 is used for extrusion molding of pellets or the like, and is provided with an extrusion die 12 and a melt kneader 11 which melts and kneads a resin material and supplies the result to the extrusion die 12.

The melt kneader 11 is provided with a cylinder 111, a screw 112 which rotates within the cylinder 111 for mixing and extruding the resin material, a hopper 113 for supplying the resin material to the cylinder 111, a heater 116 for heating the resin material within the cylinder 111, and a driving device 114 for rotating the screw 112.

By heating the cylinder 111 by the heater 116 provided in the periphery of the cylinder 111, the resin material supplied from the hopper 113 is melted. The screw 112 is rotated by the driving device 114, whereby the melt-kneaded resin material is supplied toward the extrusion die 12 while kneading.

As shown in FIG. 2, the die mold 12 is connected to the melt kneader 11 through a connection member 115. An ultrasonic vibration application apparatus 30 is installed into the mold 12. The ultrasonic vibration application apparatus 30 comprises a vibrator 31 connected to an ultrasonic supply source (not shown) and a horn 32 which is a vibration transmission member 32 attached to the tip of the vibrator 31. A horn insertion hole 22 is formed in the die 12, and reaches a channel 21. The horn 32 is inserted into the horn insertion hole 22, and the end surface thereof constitutes part of the channel 21.

As shown in FIG. 1, the horn 32 is formed in a columnar shape, and ultrasonic vibration is applied to the resin material in a molten state flowing through the channel 21 in a direction crossing the flow direction of the resin material at a right angle.

An annular flange 33 extending to an opening peripheral edge of the horn insertion hole 22 is protrusively formed halfway in the horn 32. Preferably, the flange 33 is fixed to the die 12 by a horn presser 25 and a packing 26 in the opening peripheral edge. The lower surface portion of the horn 32 constitutes an ultrasonic application part 40.

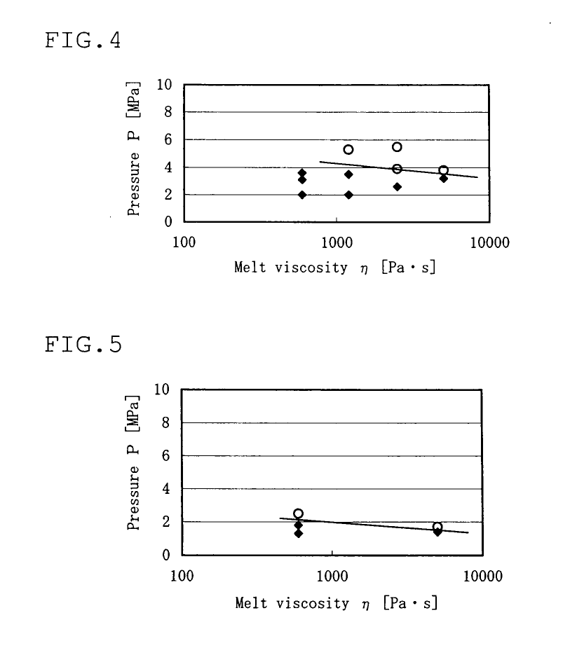

Although the ultrasonic vibration application device 30 is attached to the die 12 in FIG. 1 and FIG. 2, the configuration is not restricted thereto. For example, the ultrasonic vibration application device 30 may be attached to part of a cylinder of the melt kneader 11, as shown in FIG. 4 of Patent Document 2.

The horn may have a shape other than the columnar shape.

The resin material which has been heated and melted by means of the melt kneader 11 is supplied to the channel 21 in the mold 12 by the extruder 10. At an ultrasonic vibration application part 40 within the mold 12, ultrasonic vibration is applied from the vibrator 31 to the horn 32 by an ultrasonic oscillator. As a result, ultrasonic vibration can be applied to the resin material flowing through the channel 21 vertically with respect to the flow direction of the resin material. The molten resin material passes through the ultrasonic vibration application part 40, where dispersion is promoted, without fail (with 100% of possibility of passage). Therefore, un-uniform dispersion is not caused unlike the case of an extrusion kneader. As a result, the physical properties of the resin material including impact strength and elongation can be improved, and high-speed extrusion molding can be conducted.

In the method for applying ultrasonic vibration of the invention, the pressure P of and the melt viscosity η of the resin material are controlled when applying ultrasonic vibration in the extruder 10, whereby a load to the ultrasonic oscillator is reduced and the amount of air bubbles contained in a molded article is reduced.

The inventors provided a visualization window (not shown) beside the die 12 for visually monitoring the channel 21 in the mold 12, and investigated the behavior of the resin material when ultrasonic vibration is applied. As a result, the inventors have found the following. When ultrasonic vibration is applied when the pressure P is low with respect to the melt viscosity η, a significant amount of cavitation (air bubbles) generates in the melted resin, and the cavitation remains inside of a molded article. If ultrasonic vibration is applied when the pressure P is high to some degree, cavitation is unlikely to occur. If cavitation does not occur, it is possible to vibrate efficiently a filler which is relatively apart from the oscillator, whereby the output of the oscillator can be decreased. As a result, a load current of the ultrasonic oscillator can be rendered small, and a molded article (e.g. a strand) can be stably produced.

Specifically, it is preferred that the pressure P and the melt viscosity η of the resin material be controlled such that the relationship represented by the following formula (1) or (2) is satisfied. The relationship represented by formula (1) is applied to a case where the resin material is not subjected to vacuum deaerating in the molding apparatus, and the relationship represented by formula (2) is applied to a case where the resin material is subjected to vacuum deaerating in the molding apparatus.

P≧−(⅔)log η+6 (1)

P≧−(⅔)log η+4 (2)

The vacuum deaerating is conducted by a known method. Specifically, the vacuum deaerating is performed by connecting a vacuum pump to a suction port provided on a cylinder 111 of the melt kneader 11.

Cavitation hardly occurs at the resin pressure P satisfying the above-mentioned relationship, and as a result, a load current of an ultrasonic oscillator can be reduced and a molded article can be produced stably.

The pressure P is a value (unit: MPa) measured by means of a resin pressure gauge 117 connected to the extruder 10. In FIG. 1, the resin pressure gauge 117 is connected to the connection member 115. The melt viscosity η is a value (unit: Pa·s) measured by means of a capillary rheometer or a cone/plate rheometer at a shear rate of 10 s⁻¹ at a resin temperature at the time of molding. The resin temperature at the time of molding means the resin temperature in the vicinity of a nozzle of the mold 12 in the extruder 10.

In the extruder 10, the pressure P can be controlled by adjusting the set temperature of the heater 116 of the melt kneader 11, the rotational speed of the screw 112, and the size and number of the nozzle. The melt viscosity η can be adjusted by the set temperature of the heater 116 or the like.

If the method for applying ultrasonic vibration of the invention is applied to a filler-containing resin composition in a molten state, filler agglomerates can be efficiently broken and dispersed. Specifically, at the time of applying ultrasonic vibration by the extruder 10, filler agglomerates can be broken and dispersed by controlling the pressure P of the resin composition and the melt viscosity η of the resin material constituting the resin composition.

More specifically, it is preferred that the pressure P of the resin material and the melt viscosity η of the resin material constituting the resin composition be controlled such that the relationship represented by the following formula (3) is satisfied:

P≦−7 log η+33 (3)

By adjusting the pressure P such that formula (3) is satisfied, filler agglomerates can be broken and dispersed almost completely. Further, a high degree of dispersion of a filler can be attained even in a highly viscous liquid such as a melted resin.

In formulae (1) to (3), with an increase in the melt viscosity η of the resin material, the resin pressure P at which no cavitation occurs and the resin pressure P at which breaking and dispersion of a filler does not occur decrease. The reason therefor is assumed to be as follows. As the viscosity increases, ultrasonic vibration is significantly damped, resulting in a decrease in an acoustic pressure generated in the material.

Examples of the resin material to which the method for applying ultrasonic vibration can be applied include one or a mixture of two or more of polystyrene-based resins (e.g., polystyrene, butadiene-styrene copolymer, acyrylonitrile-styrene copolymer and acrylonitrile-butadiene-styrene copolymer), ABS resin, polyethylene, polypropylene, ethylene-propylene resin, ethylene-ethylacrylate resin, polyvinyl chloride, polyvinylidene chloride, polybutene, polycarbonates, polyacetal, polyphenylene oxide, polyvinyl alcohol, polymethyl methacrylate, saturated polyester resins (e.g., polyethylene terephthalate and polybutylene terephthalate), biodegradable polyester resins (e.g., a hydroxyl carboxylic acid condensate such as polylactic acid and a condensate of diol and dicarboxylic acid such as polybutylene succinate), polyamide resins, polyimide resins, fluorine resins, polysulfones, polyether sulfones, polyarylates, polyether ether ketones, liquid crystal polymers, polyolefin-based elastomers, polyester-based elastomers, and styrene-based elastomers.

Examples of the filler to be added to the resin material include spherical fillers such as titanium oxide, silica, calcium carbonate and glass beads, plate-like fillers such as talc, mica and clay, fibrous or rod-like fillers such as carbon nanotube, carbon fiber and glass fiber, and inorganic fillers such as strontium carbonate.

Additives such as dyes and nucleating agents can also be added.

A substance such as a low-melting alloy which is molten during extrusion and kneading but becomes solid at ordinary temperature is also included. The particle diameter is not particularly limited, but a particle diameter of 1 μm or less, particularly 0.1 μm or less is applicable. The amount of the filler to be blended is not particularly restricted, but a blend ratio of about 100 wtppm to a high blend ratio of several tens wt % is applicable.

By applying ultrasonic vibration to the resin material or the resin composition according to the method of the invention, functionality, kneadability and compatibility can be improved, and resin modification can be facilitated. Therefore, the method of the invention is suitable, for example, for producing polymers or copolymers which are widely used as reflective materials or materials for automobiles.

The method of the invention will be described in more detail referring to embodiments in which the method is applied to polystyrene and a polycarbonate composition.

### EMBODIMENT 1

The extruder shown in FIG. 1 and FIG. 2 was used. The details are as follows:

Melt kneader: A laboblast mill twin extruder (manufactured by Toyo Seiki Seisakusho Co., Ltd.) was used.

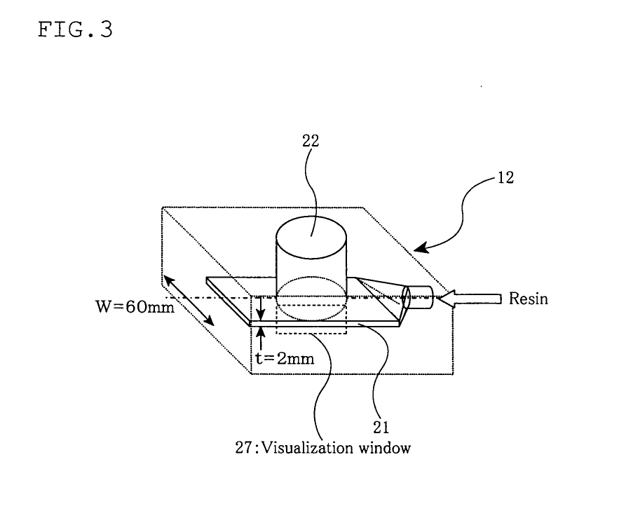

Ultrasonic vibration application apparatus: As shown in FIG. 2, a mold (die) having a horn for applying vibration to a resin composition in a vertical direction was attached. Frequency was 19 kHz and amplitude was 7 μm. The horn had a diameter of 60 mm and was made of duralumin. The depth of the channel in the ultrasonic vibration application part was 2 mm. The gap G was 0.2 mm. FIG. 3 shows a schematic perspective view showing the channel in the mold. Ultrasonic vibration was applied to a resin material in the channel having a width of about 60 mm. After the application of ultrasonic vibration, the resin material was extruded through a nozzle (not shown, having an opening diameter of 2.5 mm) in the form of a strand.

As the resin material, polystyrene (HF77-301 with an MFR of about 7.5 g/min, manufactured by PS Japan Corporation) was used.

In the ultrasonic die, a visualization window 27 made of glass was installed in the ultrasonic vibration application part (see FIG. 3) so that the state of the ultrasonic vibration application part could be observed.

In this extruder, the melt viscosity and the pressure of the molten polystyrene were changed by changing the resin temperature, the flow rate, and the opening of the die outlet. The melt viscosity was a value obtained at the resin temperature measured by means of a cone/plate rheometer (unit: Pa·s) at a shear rate of 10 s⁻¹.

The occurrence of cavitation, the state of the strand, and the current load of the ultrasonic oscillator at each condition were observed. Also, the effects brought by the vacuum deaerating were evaluated.

The results of the measurement in the case where the vacuum deaerating was not conducted are shown in Table 1, and the results of the measurement in the case where the vacuum deaerating was conducted are shown in Table 2.

TABLE 1

| | Ultrasonic vibration | | | | | | | | | | |
|---|---|---|---|---|---|---|---|---|---|---|---|
| | application conditions | | | | | | | | | | |
| | 1 | 2 | 3 | 4 | 5 | 6 | 7 | 8 | 9 | 10 | 11 |
| Vacuum | No | No | No | No | No | No | No | No | No | No | No |
| deaerating | | | | | | | | | | | |
| Resin | 240 | 240 | 240 | 220 | 220 | 220 | 200 | 200 | 200 | 180 | 180 |
| temperature (° C.) | | | | | | | | | | | |
| Melt | 600 | 600 | 600 | 1200 | 1200 | 1200 | 2500 | 2500 | 2500 | 5000 | 5000 |
| viscosity | | | | | | | | | | | |
| η (Pa · s) | | | | | | | | | | | |
| Resin | 3.1 | 2 | 3.6 | 2 | 3.5 | 5.3 | 2.6 | 3.9 | 5.5 | 3.2 | 3.8 |
| pressure P | | | | | | | | | | | |
| (MPa) | | | | | | | | | | | |
| Value of | 4.15 | 4.15 | 4.15 | 3.95 | 3.95 | 3.95 | 3.73 | 3.73 | 3.73 | 3.53 | 3.53 |
| right side | | | | | | | | | | | |
| of formula | | | | | | | | | | | |
| (1) | | | | | | | | | | | |
| Results of | | | | | | | | | | | |
| evaluation | | | | | | | | | | | |
| Cavitation | Occurred | Occurred | Occurred | Occurred | Occurred | Not | Occurred | Occurred | Not | Occurred | Not |
| generation | | | | | | occurred | | | occurred | | occurred |
| State of | Poor | Poor | Poor | Poor | Poor | Good | Poor | Good | Good | Poor | Good |
| strand | | | | | | | | | | | |
| Current | >4 | >4 | >4 | >4 | >4 | 2.3 | >4 | 2.3 | 2.3 | >4 | 2.3 |
| (A) | | | | | | | | | | | |

The melt viscosity is a value obtained at a shear rate of 10 s⁻¹.
The right side of formula (1): −(⅔) log η + 6

TABLE 2

| | Ultrasonic vibration | | | | |
|---|---|---|---|---|---|
| | application conditions | | | | |
| | 1 | 2 | 3 | 4 | 5 |
| Vacuum | Conducted | Conducted | Conducted | Conducted | Conducted |
| deaerating | | | | | |
| Resin | 240 | 240 | 240 | 180 | 180 |
| temperature | | | | | |
| (° C.) | | | | | |
| Melt | 600 | 600 | 600 | 5000 | 5000 |
| viscosity | | | | | |
| η (Pa · s) | | | | | |
| Resin | 1.3 | 1.8 | 2.5 | 1.4 | 1.7 |
| pressure P | | | | | |
| (MPa) | | | | | |
| Value of | 2.15 | 2.15 | 2.15 | 1.53 | 1.53 |
| the right | | | | | |
| side of | | | | | |
| formula (1) | | | | | |
| Results of | | | | | |
| evaluation | | | | | |
| Cavitation | Occurred | Occurred | Not | Occurred | Not |
| generation | | | occurred | | occurred |
| State of | Poor | Poor | Good | Poor | Good |
| strand | | | | | |
| Current (A) | >4 | >4 | 2.3 | >4 | 2.3 |

The right side of formula (1): −(⅔) log η + 4

Generation of cavitation was observed through a visualization window visually or by taking pictures using a video camera.

The state of the strand was evaluated based on the following criteria:

Good: The strand was not cut after the 5-minute continuous operation
Poor: The strand was cut or the strand contained air bubbles after the 5-minute continuous operation

From the results shown in Table 1 and Table 2, it was confirmed that cavitation was generated when the resin pressure was low, and the strand became porous. For that reason, the strand was broken easily during the examination. The load current of the ultrasonic oscillator was large. If the load current of the ultrasonic oscillator is large, not only it is unfavorable from an economical point of view, but also the device life is shortened.

The relation between the resin pressure P and the melt viscosity η, and the application of ultrasonic vibration under the conditions summarized in Table 1 is shown in FIG. 4.

In the figure, ∘ indicates the conditions which are judged as suitable for applying ultrasonic vibration, and ♦ indicates the conditions which are judged unsuitable for applying ultrasonic vibration.

FIG. 5 shows the relation between the resin pressure P and the melt viscosity η, and the application of ultrasonic vibration under the conditions summarized in Table 2.

From FIG. 4 and FIG. 5, it was confirmed that, when vacuum deaerating was not performed, a strand was formed stably with a low current load without suffering occurrence of cavitation in the range satisfying the following formula (1), and when vacuum deaerating was performed, a strand was formed stably with a low current load without suffering occurrence of cavitation in the range satisfying the following formula (2):

P≧−(⅔)log η+6 (1)

P≧−(⅔)log η+4 (2)

### EMBODIMENT 2

The same extruder as that used in the above-mentioned embodiment 1 was used. As the resin material, the polystyrene (PS) used in Embodiment 1 or polycarbonate (PC) (FN-1900A manufactured by Idemitsu Petrochemical Co., Ltd) was used. As the filler, titanium dicarbonate (TiO₂) having a unit particle diameter of 220 nm was used.

A bore was formed in advance in pellets of the resin material, and agglomerates of titanium dioxide were inserted into the bore while observing by means of a microscope. Thereafter, the pellets were heated to seal the bore, whereby the pellets containing the agglomerates of titanium dioxide therein were formed.

Actual filler agglomerates are supposed to differ in hardness. Therefore, as the agglomerate contained in the resin pellets, agglomerates having a particle diameter of about 0.5 to 1 mm which were granulated from the above-mentioned titanium dioxide powder (an untreated mass which is easily broken) and agglomerates having a particle diameter of about 0.5 to 1 mm which were obtained by pressurizing the powder of titanium dioxide at a pressure of 50 MPa (a hard, pressurized mass) were used.

To evaluate accurately the dispersion of the filler by the ultrasonic vibration by eliminating effects of a melt kneader exerted on the filler dispersion, the following operation was conducted.

The resin material was placed in the melt kneader, and then brought into a steady state under predetermined conditions. Thereafter, the rotation of the screw in the melt kneader was stopped. Keeping the state, the resin pellets containing agglomerates of titanium dioxide therein as prepared above was inserted into the melt kneader through a hole for a resin pressure gauge. After the lapse of 5 to 7 minutes, the screw was rotated to transport the resin and the titanium dioxide agglomerates in the melt kneader to a die, and ultrasonic vibration was applied.

A strand extruded from the nozzle was collected, and change in the agglomerates inside the strand was observed.

The melt viscosity and the resin pressure of the melted polystyrene or polycarbonate were changed by varying the resin temperature, the flow rate and the aperture of the die outlet, and strands were formed under various conditions. The dispersion state of filler agglomerates in the resulting strand was evaluated.

The results of the measurement when polystyrene was used as the resin material are shown in Table 3, and the results of the measurement when polycarbonate was used as the resin material are shown in Table 4.

TABLE 3

| | Ultrasonic vibration | | | | | | | |
|---|---|---|---|---|---|---|---|---|
| | application conditions | | | | | | | |
| | 1 | 2 | 3 | 4 | 5 | 6 | 7 | 8 |
| Resin used | PS | PS | PS | PS | PS | PS | PS | PS |
| Type of | Pressurized | Pressurized | Untreated | Untreated | Pressurized | Pressurized | Pressurized | Untreated |
| agglomerates | | | | | | | | |
| Resin | 220 | 210 | 200 | 200 | 200 | 180 | 180 | 180 |
| temperature | | | | | | | | |
| (° C.) | | | | | | | | |
| Melt | 1200 | 1700 | 2500 | 2500 | 2500 | 5000 | 5000 | 5000 |
| viscosity η | | | | | | | | |
| (Pa · s) | | | | | | | | |
| Resin | 4.5 | 5 | 3.8 | 7 | 8.6 | 5.9 | 7.5 | 8.5 |
| pressure | | | | | | | | |
| (MPa) | | | | | | | | |
| Right side | 11.45 | 10.39 | 9.21 | 9.21 | 9.21 | 7.11 | 7.11 | 7.11 |
| value of | | | | | | | | |
| formula (3) | | | | | | | | |
| Broken and | Excellent | Excellent | Excellent | Excellent | Excellent | Excellent | Poor | Poor |
| dispersed | | | | | | | | |
| state | | | | | | | | |

As for the type of the agglomerates, “pressurized” means agglomerates obtained by pressurizing titanium dioxide, and “untreated” means agglomerates obtained from titanium dioxide which was not pressurized.
The right side of formula (3): −7log η + 33

TABLE 4

| | Ultrasonic vibration | | | | |
|---|---|---|---|---|---|
| | application conditions | | | | |
| | 1 | 2 | 3 | 4 | 5 |
| Resin used | PC | PC | PC | PC | PC |
| Type | Pressurized | Pressurized | Pressurized | Pressurized | Untreated |
| of agglomerates | | | | | |
| Resin | 280 | 280 | 280 | 260 | 240 |
| temperature | | | | | |
| (° C.) | | | | | |
| Melt | 680 | 680 | 1600 | 1600 | 3700 |
| viscosity η | | | | | |
| (Pa · s) | | | | | |
| Resin | 2.2 | 3.8 | 4 | 6 | 5.8 |
| pressure P | | | | | |
| (MPa) | | | | | |
| Value of the | 13.17 | 13.17 | 10.57 | 10.57 | 8.02 |
| right side | | | | | |
| of formula | | | | | |
| (3) | | | | | |
| Broken and | Excellent | Excellent | Excellent | Excellent | Excellent |
| dispersed | | | | | |
| state | | | | | |

As for the type of the agglomerates, “pressurized” means agglomerates obtained by pressurizing titanium dioxide, and “untreated” means agglomerates obtained from titanium dioxide which was not pressurized.
The right side of formula (3): −7 log η+33

It was found that that, if the strand was extruded without applying ultrasonic vibration, each of the pressurized agglomerates and the untreated agglomerates was extruded in the strand without being broken and dispersed.

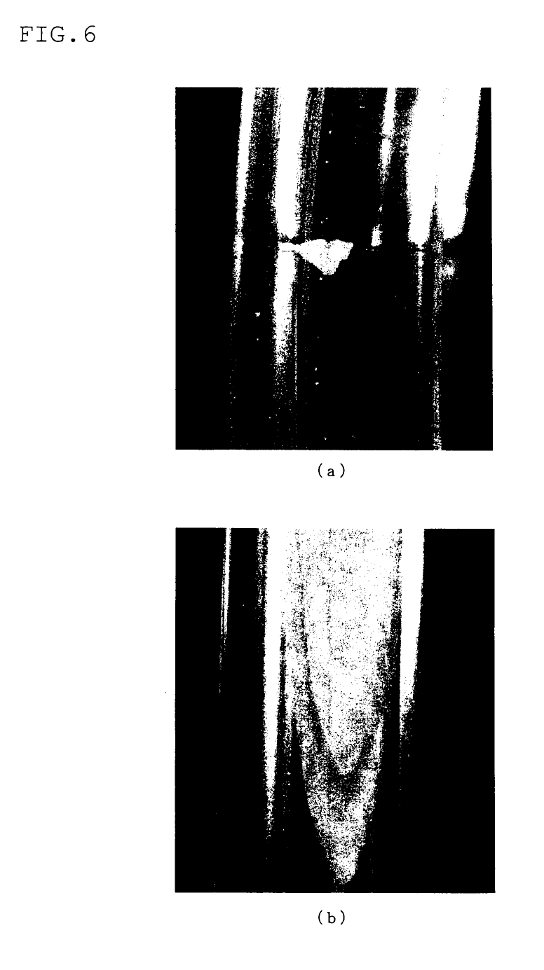

FIG. 6 are enlarged photographs showing the broken and dispersed state of the agglomerates in the strand, in which (a) shows the state in which the agglomerates were extruded without being broken and dispersed, and (b) shows the state in which the agglomerates were extruded after being broken and dispersed.

In FIG. 6(a), the agglomerates of the filler were observed near the middle portion of the strand. In FIG. 6(b), the filler agglomerates were broken and dispersed, and they were spread in the form of a white band with a radical end.

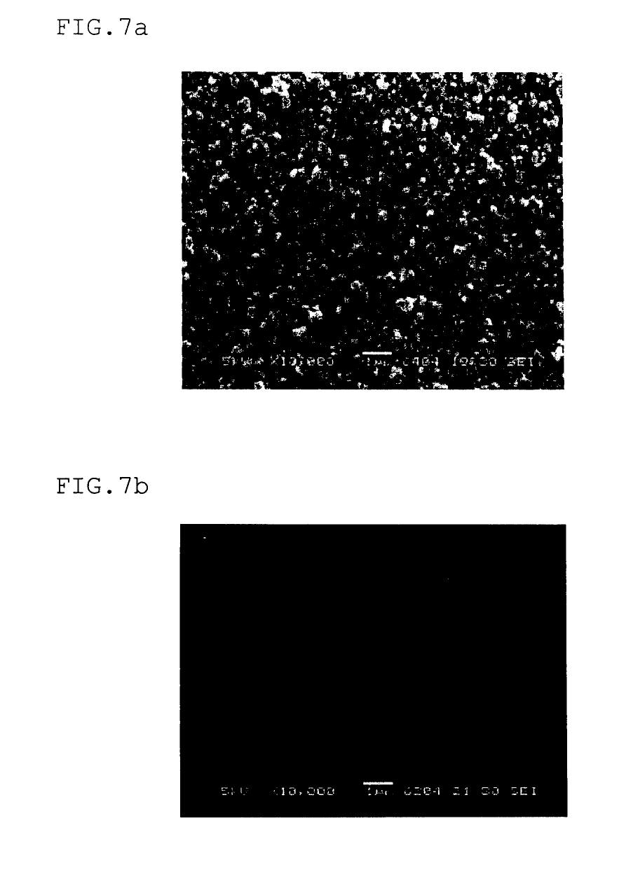

FIG. 7 are scanning electron microscopic photographs of the strand. FIG. 7a shows the state in which the agglomerates were extruded without being broken and dispersed (FIG. 6(a)), and FIG. 7b shows the state in which the agglomerates were extruded by being broken and dispersed (FIG. 6(b))

In FIG. 7(a), the fillers were present as agglomerates. In FIG. 7(b), the filler agglomerates were broken, and dispersed in the resin material in the state of a unit particle (particle size: about 220 nm) or in the state similar to the unit particle.

As for the evaluation of the “broken and dispersed state” in Table 3 and Table 4, the strand in FIG. 6(a) and FIG. 7(a) was evaluated as poor and the strand in FIG. 6(b) and FIG. 7(b) was evaluated as excellent.

FIG. 6(a) and FIG. 7(a) are the photographs of the strand prepared under condition 5 in Table 3, in which polystyrene was used. FIG. 6(b) and FIG. 7(b) are the photographs of the strand prepared under condition 8 in Table 3.

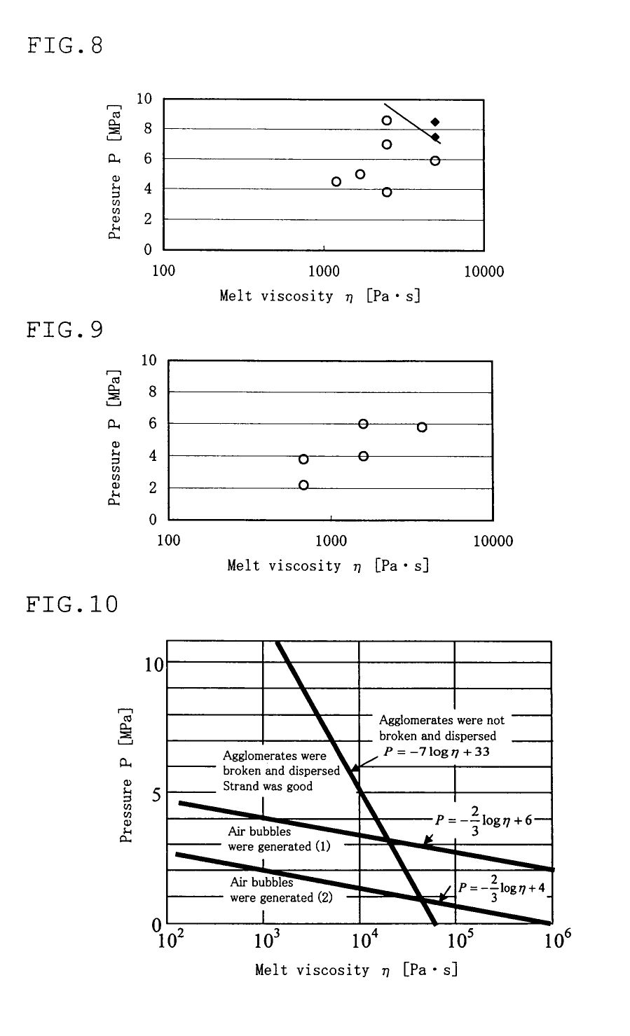

FIG. 8 shows the relationship between the resin pressure P, the melt viscosity η, and the broken and dispersed state of the filler agglomerates under the conditions in Table 3. Similarly, FIG. 9 shows the relationship between the resin pressure P, the melt viscosity η, and the broken and dispersed state of the filler agglomerates under the conditions in Table 4. In the figures, ∘ indicates the conditions under which the filler agglomerates were broken and dispersed, and ♦ indicates the conditions under which the filler agglomerates were not broken and dispersed.

From the results shown in Table 3 and Table 4, the dispersion of the filler occurred when the resin pressure was appropriate. The dependency of the filler dispersion on the viscosity was also confirmed. At the resin pressure P in the range satisfying the following formula (3), the filler agglomerates were broken and dispersed almost completely to attain a high degree of dispersion of the filler. The breaking and dispersion of the filler agglomerates hardly occurred at a pressure outside the range shown by formula (3).

P≦−7 log η+33 (3)

FIG. 10 shows the relationship between the resin pressure P, the melt viscosity η, and the effect brought by the ultrasonic vibration in Embodiments 1 and 2. In the figure, in the region indicated as “air bubble generation (1)”, air bubbles were generated when air deaerating was not performed. In the region indicated as “air bubble generation (2)”, air bubbles were generated irrespective of the operation of deaerating.

As stated above, by controlling the resin pressure P and the melt viscosity η of the resin material when applying ultrasonic vibration, the load applied to the ultrasonic oscillator can be decreased, the content of air bubbles in the molded article can be decreased, and a high degree of filler dispersion can be attained. This technology is effective for dispersing filler in a resin material, which filler is extremely fine particles having a size on the submicron or nano-order level and the dispersion of which is difficult.

### INDUSTRIAL APPLICABILITY

Using the method for applying ultrasonic vibration of the invention, it is possible to produce a liquid crystal module reflective board material (light-reflective properties) formed of a polycarbonate and TiO₂, a carbon nanotube-containing resin composition (conductivity, antistatic properties), a composite material of polycarbonate and nanosilica (both of fire retardancy and transparency can be attained), optical wavelength controlling materials formed of, for example, polycarbonate, and TiO₂, ZnO, Fe₂O₃, LaB₆, ITO or ATO.

1: A method for applying ultrasonic vibration to a resin material in a molten state by an ultrasonic vibration application apparatus being attached to a molding apparatus, wherein a load applied to an ultrasonic oscillator is reduced and an amount of air bubbles contained in a molded article is reduced by controlling the pressure P and the melt viscosity η of the resin material at the time of applying ultrasonic vibration.

2: The method for applying ultrasonic vibration according to claim 1, wherein the pressure P and the melt viscosity η of the resin material are controlled in order that the relationship of the following formula (1) or (2) is satisfied:
P≧(⅔)log η+6 (1)
P≧−(⅔)log η+4 (2)
wherein P is the pressure (MPa) of the resin material and η is the melt viscosity (Pa·s) of the resin material at a shear rate of 10 s⁻¹; formula (1) applies to a case where the resin material is not subjected to vacuum deaerating in the molding apparatus; and formula (2) applies to a case where the resin material is subjected to vacuum deaerating in the molding apparatus.

3: A method for applying ultrasonic vibration to a resin composition in a molten state which contains a filler by an ultrasonic vibration application apparatus being attached to a molding apparatus, wherein filler agglomerates are broken and dispersed by controlling the pressure P of the resin composition and the melt viscosity η of a resin material constituting the composition at the time of applying ultrasonic vibration.

4: The method for applying ultrasonic vibration according to claim 3, wherein the pressure P and the melt viscosity η of the resin composition are controlled in order that the relationship of the following formula (3) is satisfied:
P≦−7 log η+33 (3)
wherein P is the pressure (MPa) of the resin composition and η is the melt viscosity (Pa·s) at a shear rate of 10 s⁻¹ of the resin material constituting the resin composition.

5: A resin composition obtained by ultrasonic application according to the method for applying ultrasonic vibration according to claim 3.

6: A resin composition obtained by ultrasonic application according to the method for applying ultrasonic vibration according to claim 4.
